(19) United States
(12) Patent Application Publication
(10) Pub. No.: US 2006/0018071 A1
(43) Pub. Date: Jan. 26, 2006

(54) Protective device for antenna power circuit

(75) Inventor: Yoshiaki Ono, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/187,012

(22) Filed: Jul. 22, 2005

(30) Foreign Application Priority Data
Jul. 23, 2004 (JP) 2004-216436

(51) Int. Cl. H02H 3/08

(52) U.S. Cl. 361/93.1

(57) ABSTRACT

The present invention provides a device for protecting an antenna power circuit from overcurrent. A fuse and a positive thermistor are serially connected to an antenna power line, which is the output of the antenna power circuit, and power is fed to an antenna control cable via the power line. When overcurrent flows in the antenna power line due to a short circuit in the antenna control unit or due to another cause, the resistance of the positive thermistor increases and the electric current in the antenna power circuit is controlled before the fuse is melted. For this reason, the troublesome work of replacing the fuse is not required, and the system can be immediately restored from the abnormal state to its original state.

### BACKGROUND OF THE INVENTION

1. Field of the Invention

The present invention relates to a protective device for an antenna power circuit for receiving, for example, ATSC (Advanced Television Systems Committee) signals and other digital television broadcast signals.

2. Description of the Related Art

On the North American continent where ATSC digital television broadcasting (hereinafter abbreviated as “TV broadcast”) is used, smart antennas and other multidirectional antennas are coming into practical application. According to EIA-909 standards, smart antennas are required to have a receiving direction in each direction of a circle segmented into 16 parts. Among multidirectional antennas currently on the market, there are types in which the antenna is rotated with a motor to switch the receiving direction, types in which there is a plurality of antennas and the effective antenna directions are switched by switching an electronic switch ON or OFF (the antennas themselves do not rotate), and various other configurations.

Such multidirectional antennas must have a motor power source for rotating the antenna with the motor, a power source for electronic switching, or another power source, and power is commonly fed using an antenna control cable from a power source device contained within the television broadcast receiver connected to the antenna. In particular, the antenna control cable in a smart antenna is composed of six cable lines: one line for feeding an antenna control signal, one line for feeding antenna power source voltage, one line as a ground line, and the remaining three lines as open lines, and all these lines are usually grounded.

Since receiver antennas for Broadcast Satellite (BS) are provided with a low noise downconverter that includes an amplifier in the antenna, DC power is fed from the indoor unit of the BS receiver and superimposed in the coaxial cable.

When power is fed from the TV signal receiver in this manner, power is fed by way of the antenna control cable or is superimposed on the coaxial cable and fed therethrough. Therefore, an overcurrent is generated when short-circuiting accidentally occurs at the end of such cables, the motor fails, or the like, the overcurrent may potentially destroy the receiver circuit on the power source side or cause other problems, and a countermeasure thereto is required.

In power circuits for a BS antenna, conventionally known methods provide a thermistor in lieu of a fuse for protection against overcurrent during failures caused by the use of a short-circuited antenna (refer to JP-U-5-80131, for example). In order to prevent overcurrent in the power circuits of onboard electronic equipment, known methods interpose a positive thermistor in the power source line (refer to JP-U-3-101131, for example). In the case of a circuit for protecting the charging and discharging of electricity in a capacitor in which a positive thermistor is connected in parallel with a serial circuit composed of a diode and heater and in which a fuse is serially connected thereto, there are additionally known methods in which the fuse melts when overcharging occurs, and the fuse does not melt during a load short-circuit (refer to JP-A-2003-111269, for example).

However, in the smart antenna described above, protection from overcurrent is implemented by providing a fuse on the antenna power source side of the receiver in order to protect the power source on the receiver side against overcurrent brought about by motor failure or by short-circuiting of the power line on the antenna side in a power line that feeds +12 V DC power from the receiver side as a power source for an antenna-rotating motor, but the need to replace the fuse each time the fuse blows is troublesome, and in the particular case that the fuse blows during reception, it is inconvenient that the user must take time to replace the fuse and cannot watch the program that the user is enjoying. A need therefore existed for a means to protect the power source whereby the fuse is protected and fuse replacement is reduced. In response to this need, various power source protective circuits have been proposed in prior art, and among these there are those that use a positive thermistor, but there is a drawback in that adequate protection against overcurrent has not been achieved in cases such as when an abnormally high overcurrent is generated when the power source has short-circuited on the antenna side, when the motor has failed, or in other situations, or such as when an overcurrent that exceeds the tolerance of the positive thermistor is generated by lightning or the like.

### SUMMARY OF THE INVENTION

The present invention solves the above-described problems, and an object thereof is to provide a protective device for antenna power circuits that is capable of being implemented with low cost in a simple configuration, can block overcurrent before the fuse is melted when the overcurrent is generated by a power-source short circuit on the antenna side, and can alleviate troublesome fuse replacement and immediately automatically return to its original state in the absence of an abnormal situation.

In an aspect of the present invention, the protective device for an antenna power circuit for protecting the antenna power circuit from overcurrent comprises a control unit for controlling an antenna, a power line for feeding power from the antenna power circuit to the control unit, a fuse which is disposed in the power line and which melts and obstructs flow of overcurrent when the overcurrent flows in the line, and a temperature variable resistive element disposed in the power line and serially connected to the fuse.

In accordance with the present invention, the electric current of the antenna power circuit is controlled and the current fed to the antenna can be reduced without melting a fuse by increasing the resistance of the temperature variable resistive element such as a positive thermistor in response to the generation of overcurrent on the antenna side. For this reason, the work of replacing the fuse is no longer required, troublesome inconvenience is not imposed on the user, and safety and reliability can be improved.

### BRIEF DESCRIPTION OF THE DRAWINGS

FIG. 1 is a block diagram of a digital TV broadcast signal receiver provided with the protective device for an antenna power circuit related to the first embodiment of the present invention, and

FIG. 2 is a block diagram of the protective device.

### DESCRIPTION OF THE PREFERRED EMBODIMENTS

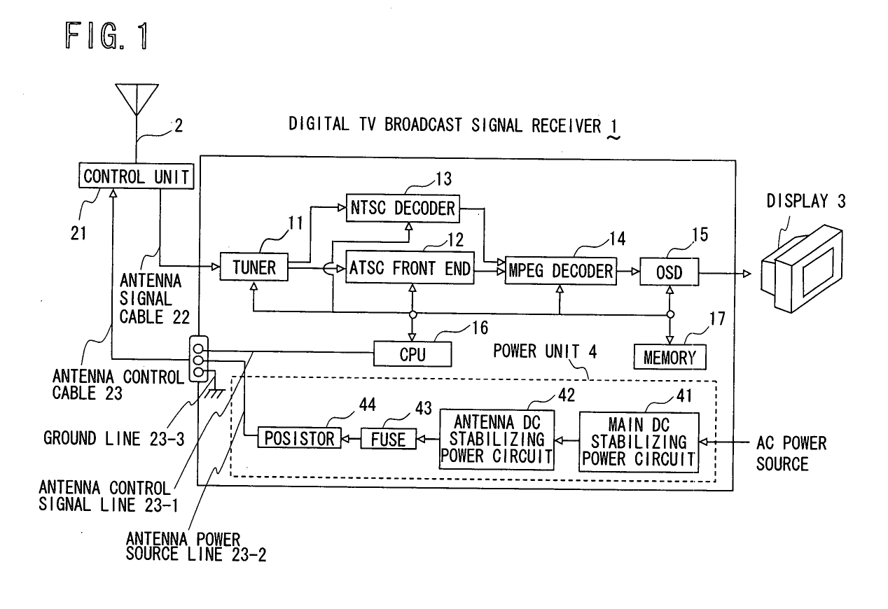

The digital TV broadcast signal receiver related to the first embodiment of the present invention is described below with reference to the diagrams. FIG. 1 shows the configuration of the digital TV broadcast signal receiver 1 related to the present embodiment. The digital TV broadcast signal receiver 1 is provided with a tuner 11 that is connected to a multidirectional antenna 2 and that receives TV broadcast signals; an ATSC front end 12 for carrying out prescribed signal processing and decoding with respect to digital TV broadcast signals received by the tuner 11; an NTSC decoder 13 for decoding analog TV broadcast signals received by the tuner 11; an MPEG decoder 14 for decoding MPEG-compressed TV broadcast signals; an onscreen display (OSD) 15 for superimposing a prescribed display image on the decoded TV broadcast signal; a main controller (hereinafter referred to as “CPU”) 16 that detects the state of reception of TV broadcast signals received by the tuner 11, controls the control unit 21 of the multidirectional antenna 2, and controls the ATSC front end 12, the NTSC decoder 13, and the like; and a memory 17 for temporarily storing decoded TV broadcast signals and storing the display image to be superimposed on the decoded TV broadcast signal. The TV broadcast signal decoded by the MPEG decoder 14 is output via the onscreen display 15 to a monitor 3 and displayed.

A power unit 4 for providing various levels of voltage power inside the receiver includes a main DC stabilizing power circuit (hereinafter referred to as “main power circuit”) 41 for generating various levels of direct current, an antenna DC stabilizing power circuit (hereinafter referred to as “antenna power circuit”) 42, a fuse 43 for overcurrent protection, and a positive thermistor (hereinafter referred to as “posistor”) 44 for limiting the current during overcurrent. When a short circuit occurs in the power source on the antenna side and overcurrent is generated, the resistance of the posistor 44 increases to control the overcurrent, and the main power circuit 41 and antenna power circuit 42 are protected.

The control unit 21 of the multidirectional antenna 2 feeds an antenna high frequency signal received by the multidirectional antenna 2 to the digital TV broadcast signal receiver 1 via an antenna signal cable 22, and a control signal is fed from the digital TV broadcast signal receiver 1 through an antenna control cable 23 to the multidirectional antenna 2. The control unit 21 is actuated in accordance with a control signal sent from the CPU 16 through the antenna control cable 23, and after the multidirectional antenna is detected, solely the specified direction from among a plurality of receiving directions of the multidirectional antenna 2 is made active. When the multidirectional antenna 2 is a type in which the antenna is rotated using a motor to switch the receiving direction, the control unit 21 controls the motor rotation and points the antenna in the specified direction. If the multidirectional antenna 2 is a type in which the effective direction of the antenna is switched by switching an electronic switch ON or OFF, solely the electronic switch connected to the antenna with the specified direction is switched ON, and the other electronic switches are switched OFF.

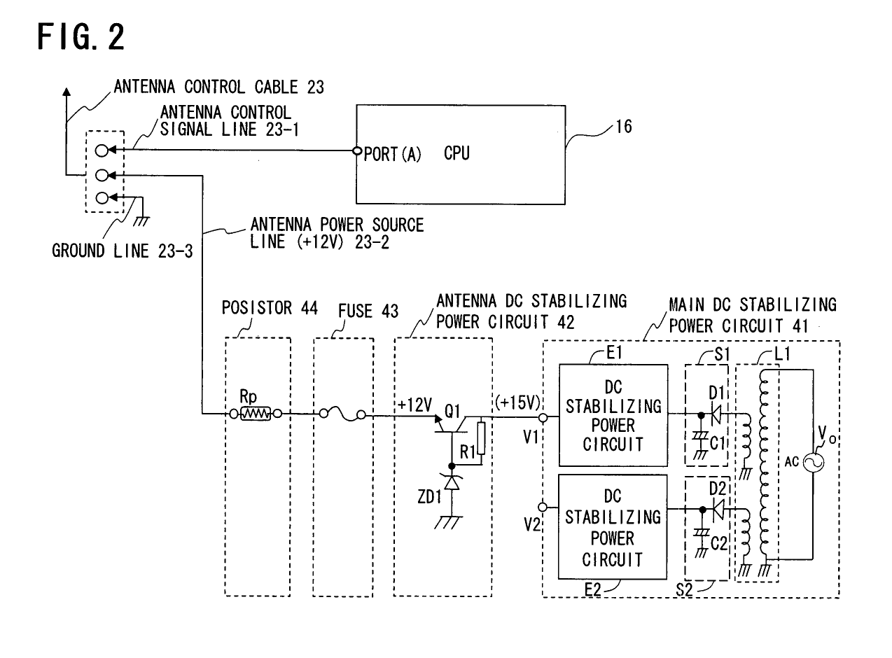

Next, the detailed structure and operation of the antenna power circuit in the power unit 4 based on the CPU 16 of the digital TV broadcast signal receiver 1 is described in detail with reference to FIG. 2. In FIG. 2, the main power circuit 41 is configured so that when AC power voltage V₀ is fed to the primary side of an AC transformer L1, the AC voltages obtained as a result of voltage division from the secondary side are rectified into the required direct current by rectifiers S1 and S2 composed of a rectifying diode D1 and capacitor C1, and a rectifying diode D2 and capacitor C2, respectively, and then fed to the DC stabilizing power circuits E1 and E2 to be drawn out as stabilized DC voltages V1 and V2.

When the resulting DC stabilizing power voltage V1 is set to +15 V, an input voltage of +15 V is applied to the antenna power circuit 42, and the antenna power circuit 42 obtains a stabilized DC voltage of +12 V from the stabilizing voltage circuit that is composed of a transistor Q1, a constant-voltage diode (Zener diode) ZD1 selected for the required voltage (+12V, in this case), and a resistor R1. The resulting +12V is fed as antenna DC voltage via the fuse 43 and the posistor Rp44 to the antenna control unit 21 via the antenna control cable 23.

The antenna control cable 23 is not limited to a single line, and smart antennas have the configuration of a modular cable comprising six lines. The lines comprise a cable that exits from port (A) of the CPU 16 and forms an antenna control signal line 23-1 for transmitting antenna control signals, a cable that forms an antenna power line 23-2 for supplying antenna power, a cable for the ground line 23-3, and three unused cables; and the three unused cables are the same as the ground line 23-3. To combine the connection cables for the antenna into a single cable, the antenna power voltage and the antenna control signal from the CPU 16 can be superimposed in the antenna signal cable 22 from the antenna and sent from the receiver side to the antenna side.

In this configuration, when overcurrent is generated due to a short-circuited power line (+12 V) on the antenna side, or due to another cause, the electric current flowing to the posistor Rp44 increases and creates heat, and the resistance increases. As a result, the overcurrent flowing to the power circuit is controlled and the power circuit is protected. The fuse 43 does not ordinarily melt because the overcurrent is absorbed by the posistor Rp44, but does melt when an overcurrent that exceeds the capacity of the posistor Rp44 is generated due to motor failure, or when abnormal electric current flows due to lightning or another cause, and the fuse together with the posistor Rp44 protects the power unit 4 including the antenna power circuit 42 with a twofold effect of controlling the electric current.

Since normal electric current returns when the short circuit in the power voltage line (+12 V) on the antenna side is resolved or the overcurrent is eliminated, normal power circuit operation is automatically restored.

Described next as another embodiment is a method in which the posistor 44 is disposed in the first stage of the antenna power circuit 42 and is inserted between the main power circuit 41 and antenna power circuit 42 to control overcurrent. A DC stabilizing power voltage of +15 V is obtained from the output voltage V1 of the main power circuit 41, and when input voltage (+15 V, in this case) is applied to the antenna power circuit 42 via the posistor Rp44, the antenna power circuit 42 obtains a stabilized DC voltage of +12 V from the stabilizing voltage circuit that is composed of a transistor Q1, a constant voltage diode (Zener diode) ZD1 selected for the required voltage (+12 V, in this case), and a resistor R1. The resulting +12 V is fed as antenna DC voltage via the fuse 43 to the antenna control unit 21 via the antenna control cable 23.

In this configuration, when overcurrent is generated due to a short-circuited power line (+12 V) on the antenna side, or due to another cause, the electric current flowing to the posistor Rp44 increases, but the overcurrent is absorbed by the posistor Rp44, and the power circuit is protected. At the same time, when the input voltage to the antenna power circuit 42 falls below +12 V due to the voltage drop across the posistor Rp44, the antenna power circuit 42 no longer operates stably, the collector voltage of the transistor Q1 decreases when the input voltage decreases further, the transistor Q1 switches OFF, the power voltage supply from the antenna power circuit 42 is stopped, the current in the fuse 43 is thereby cutoff, the power circuit is protected, and melting of the fuse 43 is avoided.

Since the overcurrent is eliminated and normal electric current returns when the short circuit in the power voltage line (+12 V) on the antenna side is resolved, the resistance of the posistor Rp44 is reduced and the antenna power circuit 42 can be automatically restored to normal operation. Thus, the posistor Rp44 doubly functions to protect power circuits by using both current control and voltage control.

In accordance with the protective device for an antenna power circuit as described above, when the antenna control cable is accidentally short-circuited or when overcurrent brought about by motor failure or another cause is generated in the antenna control unit to which power is fed from the antenna control cable, overcurrent is prevented by the current limiting effect of the power source protective circuit in the receiver, the fuse is prevented from melting, and the power circuit is reliably protected. Once the abnormal situation in which overcurrent flows due to a short circuit or another factor is resolved, the power source can be automatically restored to its original state, and the user is therefore relieved of the trouble of replacing the fuse. Even if the power source is short-circuited or other trouble occurs when a TV program is being viewed, the original picture can be enjoyed with a minimal amount of waiting time.

Furthermore, a more safe and highly reliable receiver can be obtained because it is possible to set the system so that the main power of the receiver is switched OFF by CPU control to improve safety when the antenna power source has developed a short circuit. Even when the short circuit in the antenna power source has been resolved, the system is not automatically restored, and once the safety of the entire device has been confirmed while the main power source of the receiver is kept OFF, the main power is switched on again to restart the system.

The present invention is not limited to the above-described embodiments, and a variety of modifications are possible. For example, the power circuit can be protected by stopping the operation of the antenna power circuit 42 and controlling the overcurrent by inserting the posistor 44 in series between the main power circuit 41 and the antenna power circuit 42, and reducing the input voltage applied from the main power circuit to the antenna power circuit during overcurrent by virtue of the voltage drop across the posistor 44. A power source protective device can thereby be formed with low cost in a simple configuration, and since a triple safeguard can be implemented with a fuse, a posistor, and a temporary stoppage of the antenna power circuit during overcurrent, burning or damage to the receiver can be prevented in advance, and a very safe, highly reliable power source protective circuit can be provided.

Furthermore, in the embodiments described above, a single posistor is used to absorb overcurrent in the antenna power circuit, but it is possible to increase the electric current capacity when the posistor absorbs overcurrent by using two or more posistors in parallel; and the effect of controlling the overcurrent can be increased by connecting two or more posistors in series and increasing the overcurrent-induced voltage-drop sensitivity of the posistors.

This application is based on Japanese patent application 2004-216436 filed in Japan dated Jul. 23, 2004, the contents of which are hereby incorporated by references

What is claimed is:

1. A protective device for an antenna power circuit for protecting the antenna power circuit from overcurrent, comprising:
a control unit for controlling an antenna;
a power line for feeding power from the antenna power circuit to the control unit;
a fuse which is disposed in the power line and which melts and obstructs flow of overcurrent when the overcurrent flows in the line; and
a temperature variable resistive element disposed in the power line and serially connected to the fuse.

2. The protective device according to claim 1, wherein the temperature variable resistive element is a positive thermistor.

3. The protective device according to claim 2, wherein a plurality of positive thermistors are connected in parallel or in series.

4. A protective device for an antenna power circuit for protecting the antenna power circuit from overcurrent, comprising:
a control unit for controlling an antenna;
a power line for feeding power from the antenna power circuit to the control unit;
a fuse which is disposed in the power line and which melts and obstructs flow of overcurrent when the overcurrent flows in the line; and
a temperature variable resistive element disposed in the power line and serially connected to the fuse; wherein
the antenna is a multidirectional antenna, and
the control unit controls direction of the multidirectional antenna.

5. The protective device according to claim 4, wherein the temperature variable resistive element is a positive thermistor.

6. The protective device according to claim 4, wherein a plurality of positive thermistors are connected in parallel or in series.

7. The protective device according to claim 4, wherein the antenna power circuit includes a main DC stabilizing power circuit serving as a receiver DC power source to which the antenna is connected; and an antenna DC stabilizing power circuit supplied with power from the main DC stabilizing power circuit.
